(19) United States
(12) Patent Application Publication
(10) Pub. No.: US 2021/0080157 A1
(43) Pub. Date: Mar. 18, 2021

(54) SYSTEMS AND METHODS FOR VAPOR COMPRESSION REFRIGERATION USING A CONDENSER APPARATUS

(71) Applicant: Jesse Krug, Tuscon, AZ (US)

(72) Inventor: Jesse Krug, Tuscon, AZ (US)

(21) Appl. No.: 17/024,358

(22) Filed: Sep. 17, 2020

Related U.S. Application Data
(60) Provisional application No. 62/901,650, filed on Sep. 17, 2019.

(51) Int. Cl. F25B 30/06; F25B 39/00; F25B 41/04; F25B 43/00; F02G 1/053

(52) U.S. Cl. CPC F25B 30/06; F25B 39/00; F25B 41/04; F25B 2300/00; F02G 1/053; F25B 2339/04; F25B 43/006

(57) ABSTRACT

Various embodiments of a generator system featuring a condenser which converts waste heat from a heat pump into electricity are disclosed herein.

### CROSS REFERENCE TO RELATED APPLICATIONS

This is a non-provisional application that claims benefit to U.S. provisional application Ser. No. 62/901,650 filed on Sep. 17, 2019, which is herein incorporated by reference in its entirety.

### FIELD

The present disclosure generally relates to the repurposing of waste heat in vapor compression refrigeration, and in particular, to a system and method for the harnessing of waste heat in a vapor compression refrigeration system using a condenser apparatus.

### BACKGROUND

Vapor compression refrigeration is one of the most widely used methods for air conditioning of buildings and automobiles for both consumer and commercial purposes. Waste heat and waste water are inevitable byproducts of vapor compression refrigeration. Thus, there is an opportunity to harvest energy provided by waste heat and waste water.

It is with these observations in mind, among others, that various aspects of the present disclosure were conceived and developed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an illustration showing a first embodiment of a refrigeration system having a dual Stirling engine arrangement;

FIG. 2 is an illustration showing the first embodiment of a condenser of the refrigeration system of FIG. 1; and

FIG. 3 is a cross-sectional view of the condenser taken along line 3-3 of FIG. 2;

FIG. 4 is an illustration showing a second embodiment of the refrigeration system having a single Stirling engine arrangement;

FIG. 5 is a perspective view of a condenser of the refrigeration system of FIG. 4;

FIG. 6 is an opposite perspective view of the condenser of FIG. 5;

FIG. 7 is a top view of the condenser of FIG. 5;

FIG. 8 is a bottom view of a lid of the condenser of FIG. 5;

FIG. 9A is a block diagram showing a flow of refrigerant, heat and power according to the system of FIG. 1;

FIG. 9B is a block diagram showing the flow of air, refrigerant, energy and heat of the generator system of FIGS. 1 and 4 in the case of a shut-off compressor;

FIG. 9C is a block diagram showing the flow of air, refrigerant, energy and heat of the generator system of FIG. 1 in the case of slowing the compressor after a predetermined temperature is reached in the condenser such that the compressor only adds as much heat as the Stirling engine can utilize; and

FIG. 9D is a block diagram showing a flow of refrigerant, heat and power according to the system of FIG. 4.

Corresponding reference characters indicate corresponding elements among the view of the drawings. The headings used in the figures do not limit the scope of the claims.

### DETAILED DESCRIPTION

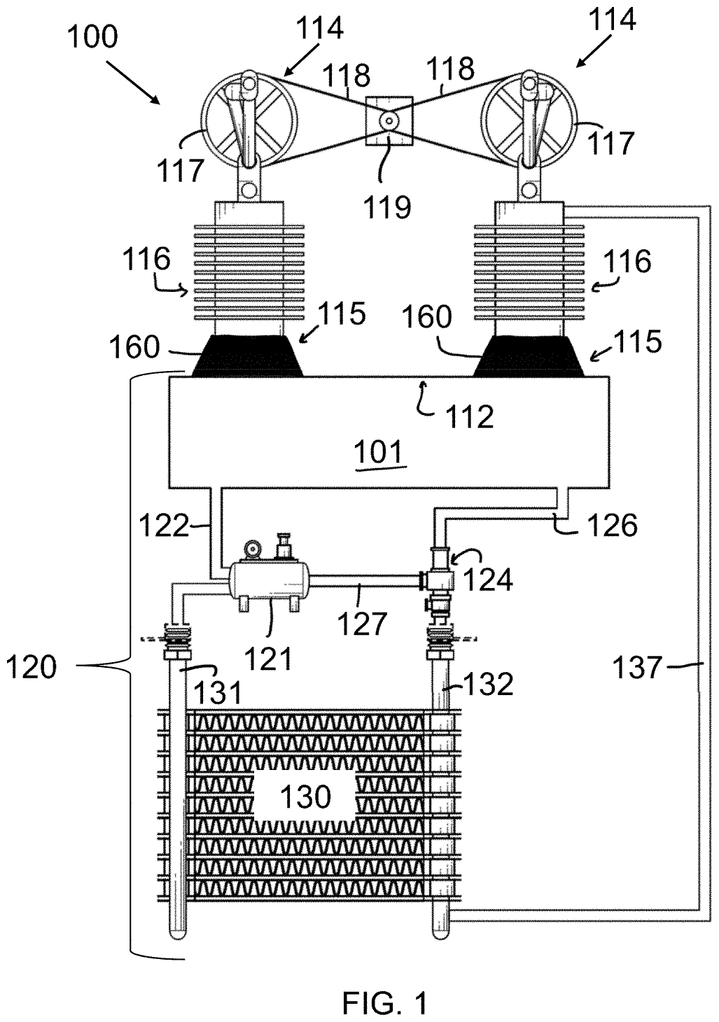

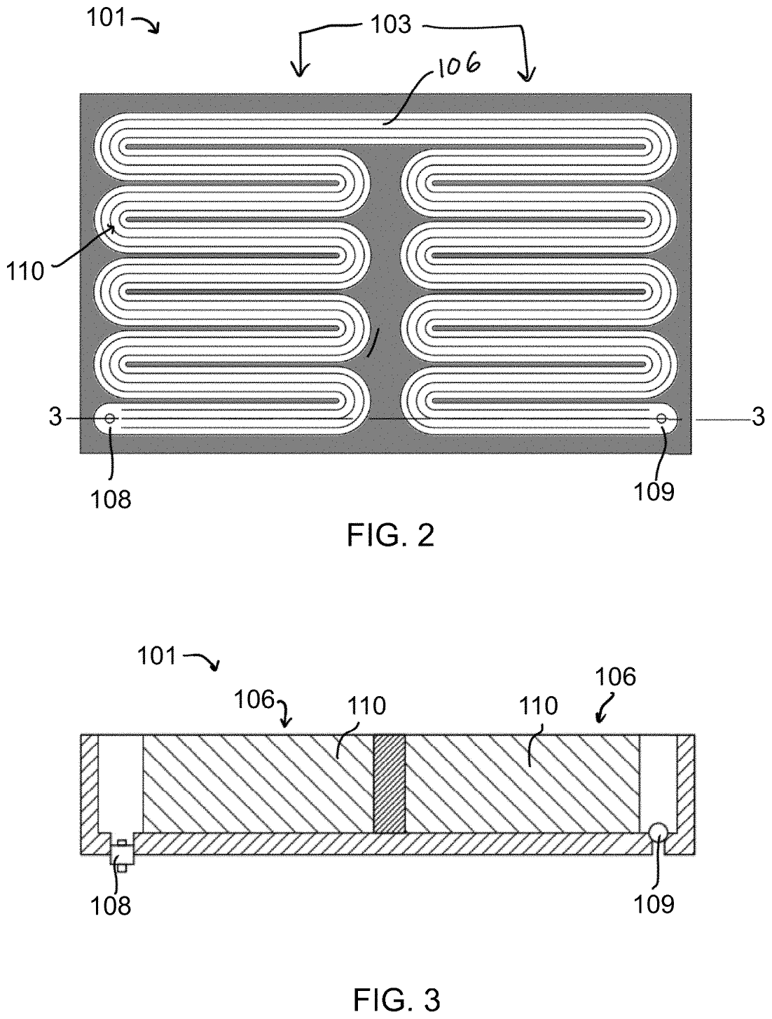

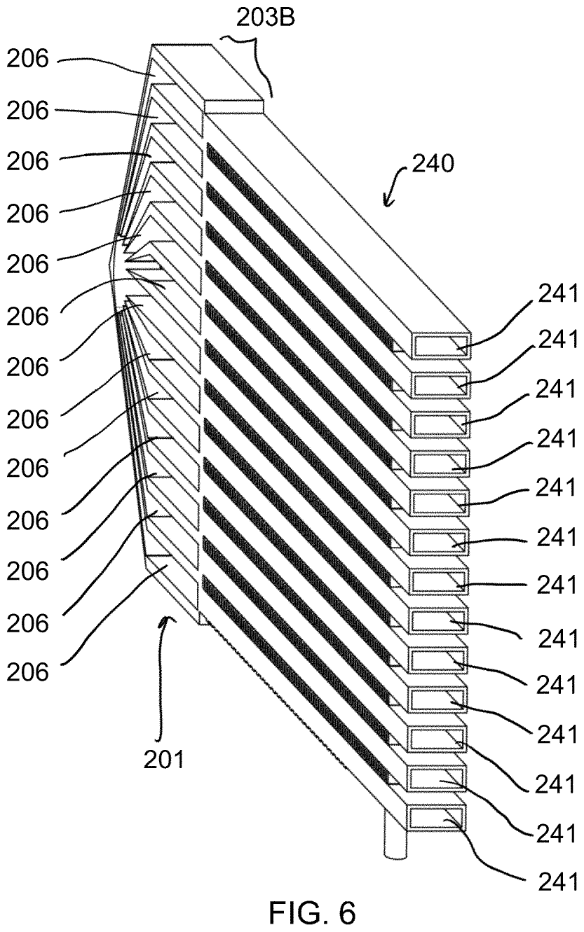

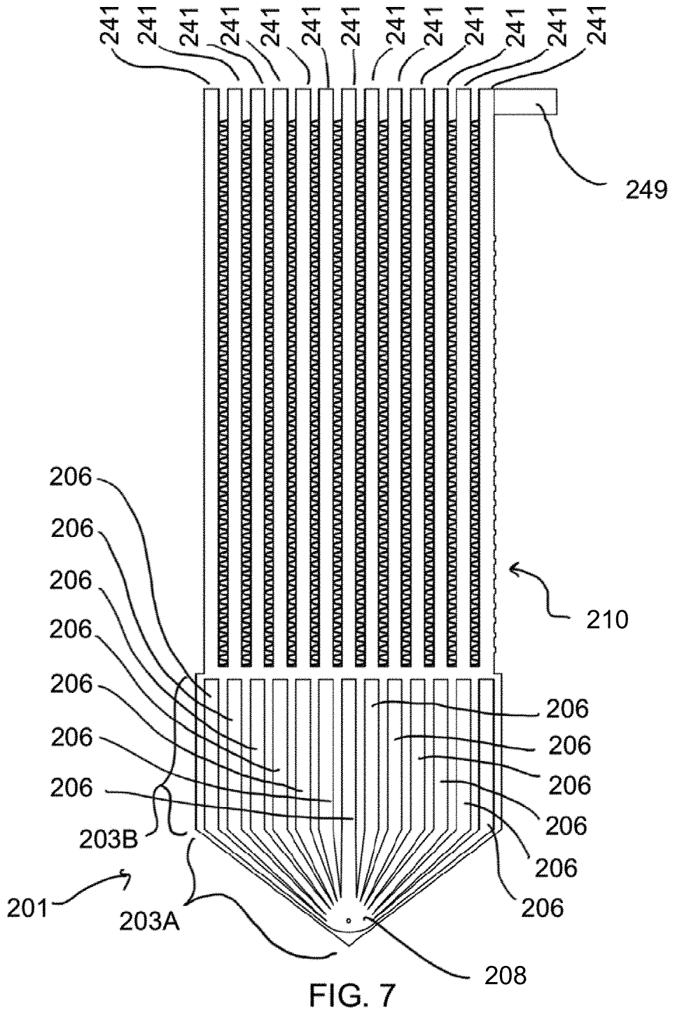

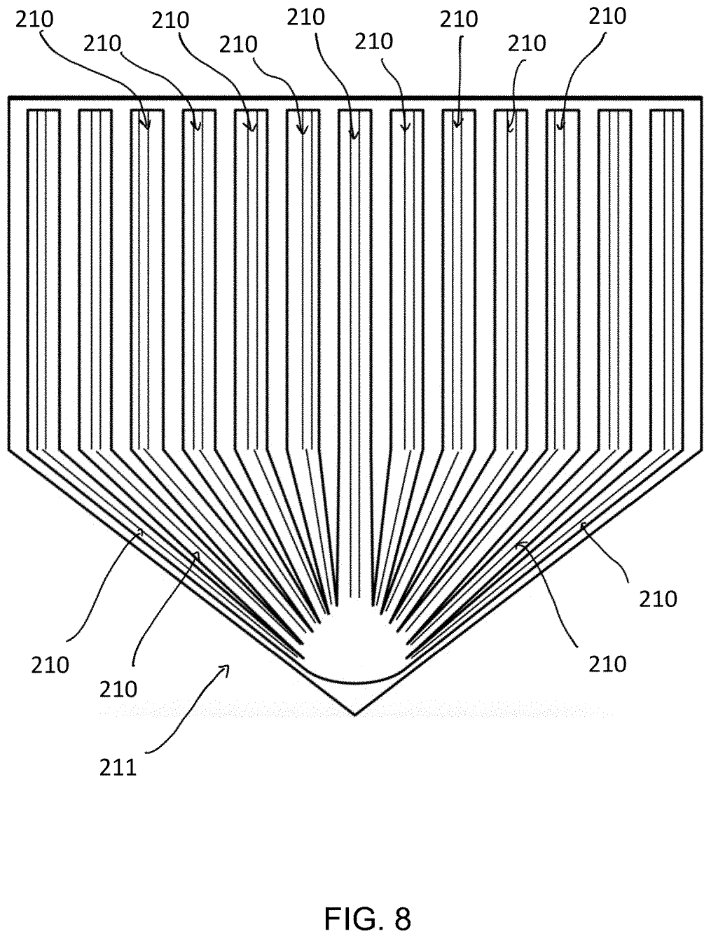

Various embodiments of an improved refrigeration system utilizing a condenser to harvest energy from waste heat produced by a vapor compression refrigeration system are disclosed herein. In particular, the refrigeration system includes one or more Stirling engines situated in thermal communication with a condenser of a heat pump to convert waste heat absorbed by the condenser into mechanical work in the form of rotational motion of the one or more Stirling engines. Each of the one or more Stirling engines are in operative communication with an alternator for conversion of mechanical work into electricity, thereby improving efficiency of the refrigeration system. Referring to the drawings, embodiments of the generator system is illustrated and generally indicated as 100 and 200 in FIGS. 1-9D.

Referring to FIGS. 1-3 and 9A-9C, a first embodiment of the refrigeration system 100 comprises a heat pump 120 in operative association with one or more Stirling engines 114. The heat pump 120 is embodied as a vapor compression refrigeration system utilizing a condenser 101 to draw ambient heat from one environment using an evaporator 130 and release heat at the condenser 101. The refrigeration system 100 further includes one or more Stirling engines 114, with each Stirling engine 114 having a wheel 117, a cold section 116 and a hot section 115, wherein the hot section 115 rests on an outer side of a lid (not shown) of the condenser 101. Temperature differentials created by the interaction of air heated by the condenser 101 contained at the hot section 115 of the Stirling engine 114 and cooler ambient air contained at the cold section 116 cause the wheel 117 of the Stirling engine 114 to turn, thereby absorbing heat and outputting mechanical work. As shown in FIG. 1, the wheel 117 of the Stirling engine 114 is in operative communication with an alternator 119 via a belt 118, thereby converting the mechanical work in the form of rotational motion of the wheel 117 into electricity.

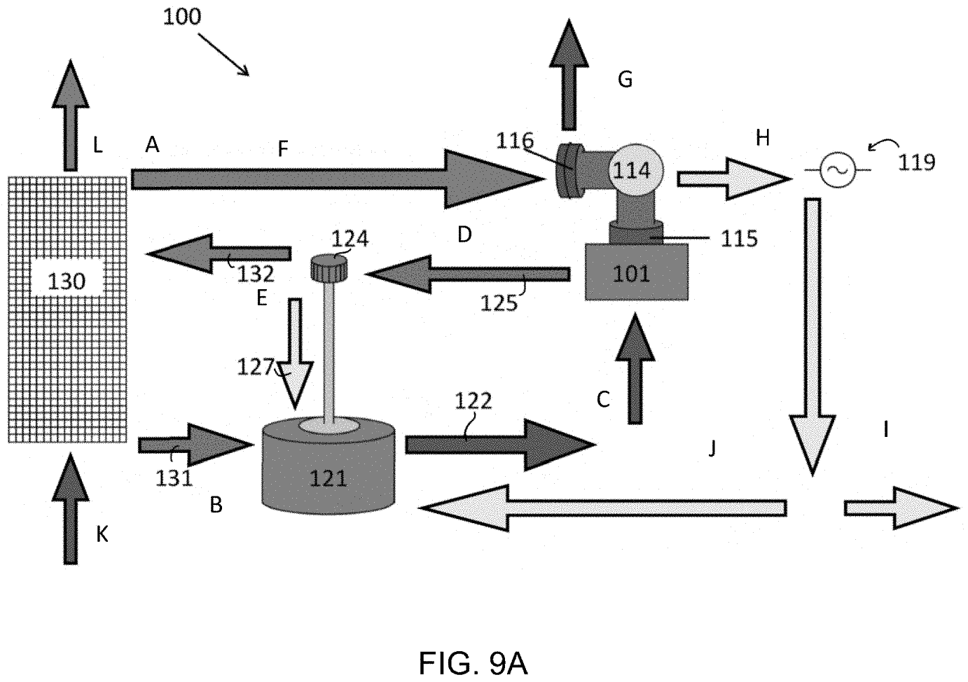

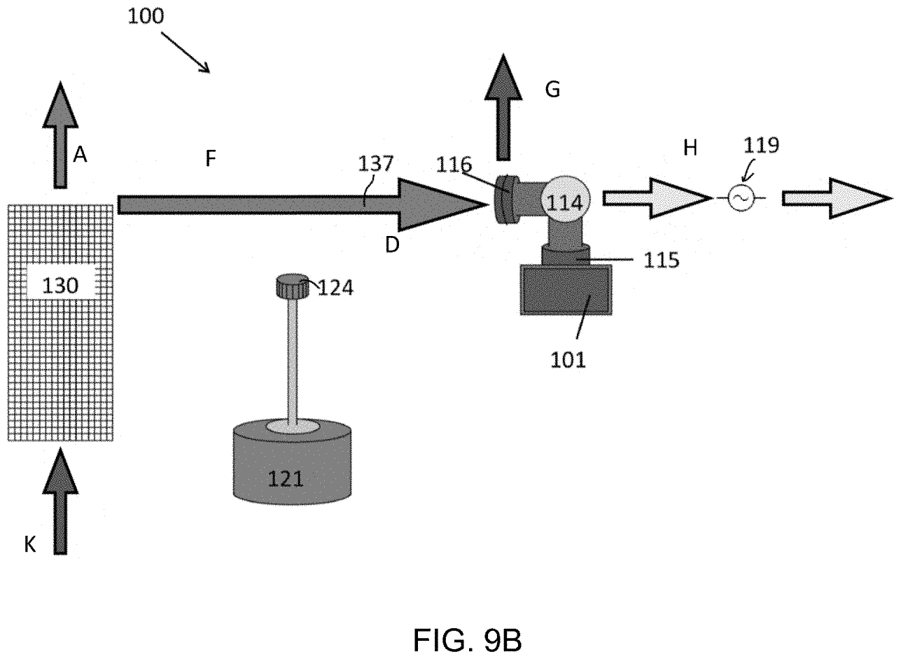

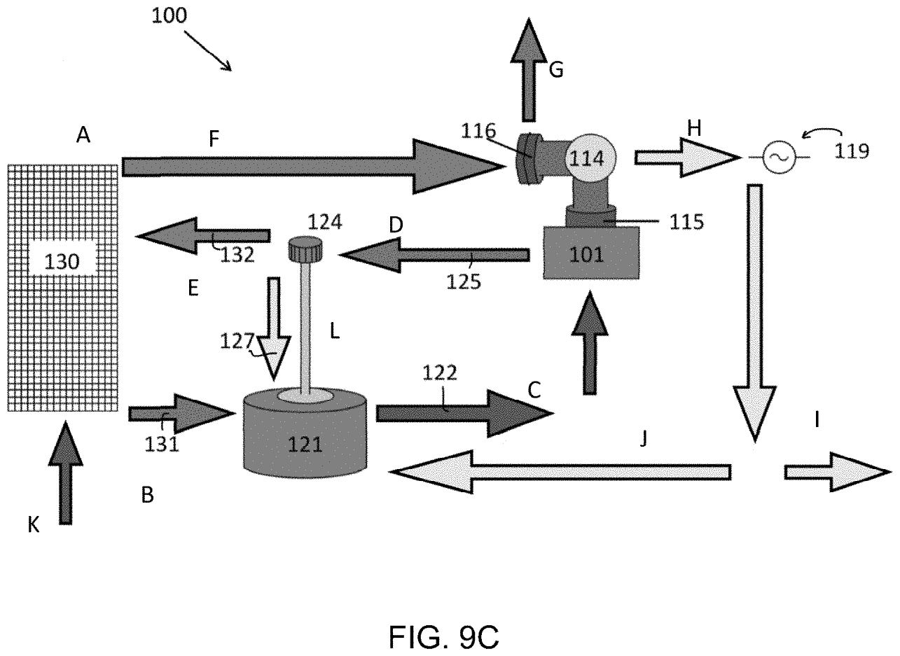

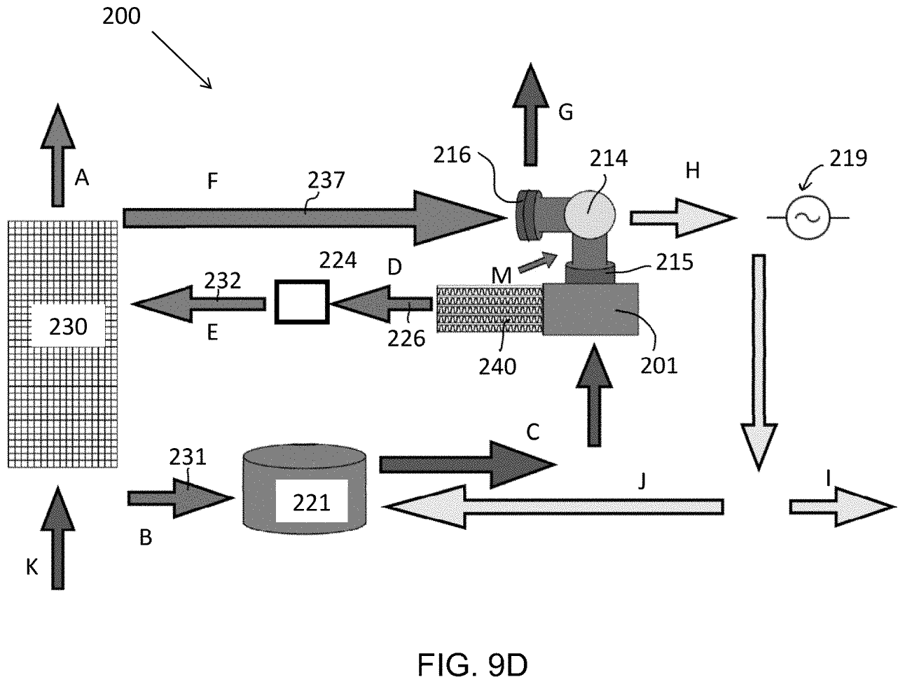

As shown in FIGS. 1-3 and 9A-9C, the heat pump 120 of the refrigeration system 100 includes the condenser 101, evaporator 130, a compressor 121 and a turbo-expander 124, the turbo-expander 124 and the compressor 121 being operatively connected via a shaft 127. When gas is compressed, mechanical energy is traded for potential energy in the form of a pressure difference from a high-pressure side and a low-pressure side of the refrigeration system 100. Refrigerant is compressed to a higher pressure (and as a result, a higher temperature) using the compressor 121. The hot, pressurized refrigerant gas is then routed to the condenser 101 via a compressor-to-condenser line 122, where the refrigerant gas is cooled and condensed and heat drawn out of the condenser 101 and into the hot section 115 of one or more Stirling engines 114. This results in a lower pressure at the exit valve 109 of the condenser 101. The cooled liquid refrigerant is then routed from the condenser 101 to the turbo-expander 124 via a condenser-to-expander line 126, where the liquid refrigerant undergoes isentropic expansion and is transformed into a cooled vapor-liquid mixture. The cooled refrigerant then flows to the evaporator 130 via an expander-to-evaporator line 132, where the evaporator 130 absorbs ambient heat in the environment and vaporizes the refrigerant, and the refrigerant is subsequently routed to the compressor 121 via an evaporator-to-compressor line 131, thereby starting the cycle again. As the refrigerant seeks equilibrium, the refrigerant is drawn over an expander wheel (not shown) of the turbo-expander 124, thereby recovering some of the potential energy back as mechanical work. The movement of the refrigerant over the expander wheel also takes load off of the motor (not shown) driving the compressor 121, as the compressor 121 and turbo-expander 124 are connected via shaft 127. This arrangement improves a coefficient of performance of the heat pump 120. In other embodiments, including the use of a conventional HVAC system as a heat pump 120, the turbo-expander 124 is replaced with an expansion valve 224 (FIG. 9D) and the shaft 127 is removed. Referring to FIGS. 9A-9D, captions A-M are shown in Table 1. Red, violet and blue colors respectively refer to high-temperature (hot), medium-temperature (warmed/cooled), and cooled (blue) fluid.

TABLE 1

| | |
|---|---|
| A | cold air out |
| B | warmed low pressure refrigerant |
| C | hot compressed refrigerant |
| D | cooled compressed refrigerant |
| E | cold low pressure refrigerant |
| F | cooling medium to cold piston |
| G | heat transferred out of working fluid |
| H | heat converted into mechanical work |
| I | external power in |
| J | power used to drive compressor |
| K | hot air in |
| L | work to drive compressor |
| M | remaining heat out of radiator |

As further shown in FIGS. 1-3 and 9A-9C, the condenser 101 is configured to exchange heat with each Stirling engine 114, rather than the environment. In some embodiments, the condenser 101 includes one or more sections 103 with a continuous winding channel 106 that occupies most of its volume. The channel 106 is configured to receive a refrigerant at an entrance valve 108 and release the refrigerant at an exit valve 109. Inside each section 103 is a plurality of cooling fins 110 that run parallel to a direction of flow of refrigerant and curve with the channel 106, as shown in FIG. 1. Each of the plurality of cooling fins 110 extend from an inner side of a lid (not shown) of the condenser 101. On an outer side 112 of the lid 111 of the condenser 101 rests on each respective Stirling engine 114. In some embodiments, each section 103 of the condenser 101 is coupled to a single Stirling engine 114. In the embodiment shown in FIG. 1, two Stirling engines 114 rest on one two sections 103 of the condenser 101.

In some embodiments, an area of the condenser 101 not in contact with a Stirling engine 114 is insulated to prevent heat loss. The condenser 101 is modular in design while the entire condenser 101 may be cast or milled out of one piece defining multiple sections 103 in serial arrangement. In one aspect, the sections 103 are scaled to the number of Stirling engines 114 being utilized. For a condenser 101 with multiple sections 103, the Stirling engines 114 do not all need to be the same model. In some embodiments, the Stirling engines 114 are optimized for progressively lower temperatures, since the refrigerant loses heat while traveling through each section 103 of the condenser 101. In other embodiments, the condenser 101 leads into a conventional radiator condenser (not shown) to increase the efficiency of the heat pump 120 without dramatically increasing running costs; the condenser 101 and radiator (not shown) are separated by a ball valve 109. In this manner, hot refrigerant may be held in the condenser 101 while the Stirling engine 114 continues to operate when the compressor 121 is turned off. In some embodiments, the condenser 101 is insulated with a 3-centimeter or thicker layer of mineral wool or aerogel (not shown). Insulating the condenser 101 ensures that as much heat as possible is forced to run through each Stirling engine 114 for conversion into mechanical work, a process which will be further disclosed below. As shown, the exit valve 109 of the condenser 101 is connected to the turbo-expander 124 with a condenser-to-expander line 126. In some embodiments, the condenser-to-expander line 126 may be embodied using ½ inch drawn type K tubing.

The Stirling engine(s) 114 may be soldered or welded to the lid (not shown) of the condenser 101. As noted above, the lid includes a plurality of thin cooling fins 110 which are disposed into the channel 106 of the condenser 101. As hot liquid refrigerant runs through the channel 106, the cooling fins 110 draw heat out of the refrigerant in the channel 106 of the condenser 101 and into a hot section 115 of each Stirling engine(s) 114. As a quantity of gas contained in the hot section 115 is heated, the gas expands and cools, moving to a cold section 116 such that more heat will be drawn into the hot section 115, thereby driving a piston (not shown) for each Stirling engine(s) 114. The motion of each respective Stirling engine 114 produces a mechanical rotational energy which is transferred to an alternator 119 that converts the mechanical rotational energy into usable electricity. This generated electricity can be used to operate the compressor 121 for continuing the cycle or stored in a battery (not shown). In some embodiments, each section 103 of the condenser 101 may be associated with a different model of Stirling engine 114 individually optimized for progressively lower temperatures as the refrigerant is cooled. In some embodiments as shown in FIG. 1, to add additional heat to the hot section 115 of the Stirling engine 114, the hot section 115 may optionally include a thermal accumulator 160, the thermal accumulator 160 including a section of glass with a black backing to trap additional heat from sunlight or another light source. In the embodiment of FIG. 1, the thermal accumulator 160 may add additional heat to achieve an ideal temperature for the Stirling engines 114 to function. Given that the compressor 121 generates heat within the refrigeration system 100, any heat collected by the Stirling engines 114 is load taken off the compressor 121.

As previously described, once the cooled refrigerant leaves the expander wheel of the turbo expander 124, the cooled refrigerant is routed to the evaporator 130 via an expander-to-evaporator line 132. In some embodiments, the expander-to-evaporator line 132 and an evaporator-to-compressor line 131 are embodied with 2 inch annealed Type K copper tubing. Because the strength requirements are relatively low, the tubing for the expander-to-evaporator line 132 and the evaporator-to-compressor line 131 can be bent based on the needs of the installation. The evaporator 130 may be embodied as a stainless steel radiator with a plurality of tubes (not shown) for the refrigerant and fins (not shown) welded to the tubes to increase surface area. In some embodiments, fans (not shown) may cover the area of the evaporator 130 to blow warm air over it and warm up the now-cooler refrigerant before it is compressed again using the compressor 121. Moisture in the air being blown over the cold evaporator 130 condenses into liquid water. In the vast majority of heat pump applications, this water is usually dumped wherever is convenient. However, in the refrigerant system 100 any condensate water is collected using a pan (not shown) and pumped by a water pump (not shown) from the evaporator 130 back to each Stirling engine 114 through a water return line 137. As the water evaporates at the cold section 116 of each respective Stirling engine 114, the temperature differential between the hot section 115 and cold section 116 is increased, thereby also increasing the amount of mechanical work generated by each Stirling engine 114. Because the water return line 137 is under relatively low pressure, the water return line 137 can be made of any easily workable or soft flexible tubing.

As described above, the number of Stirling engines 114 used may vary between embodiments, and may each be placed at different sections 103 of the condenser 101. The refrigerant travels through the condenser 101 in a linear fashion, thus each of the Stirling engines 114 would not likely spin at the same speed. In some embodiments, each Stirling engine 114 is attached to its own alternator 119. In other embodiments as shown in FIG. 1, each Stirling engine 114 may be paired up with another Stirling engine 114 to drive a differential gear (not shown) of a single alternator 119. For embodiments having more than two Stirling engines 114, a series of differential gears (not shown) or more than one alternator 119 may be used.

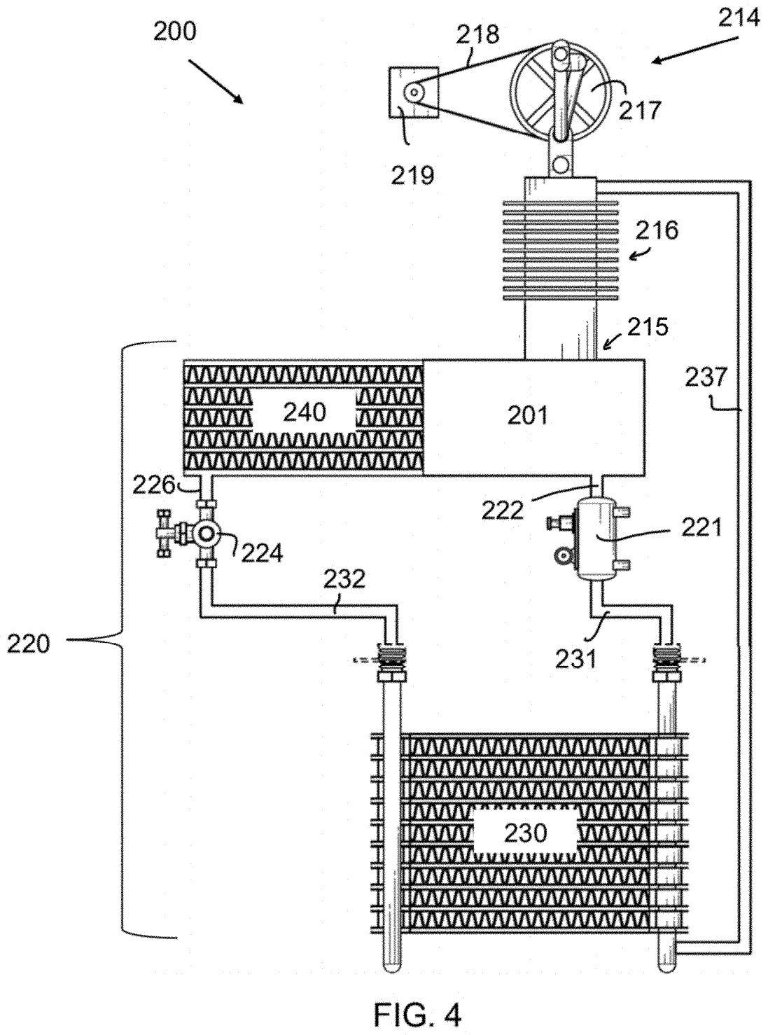

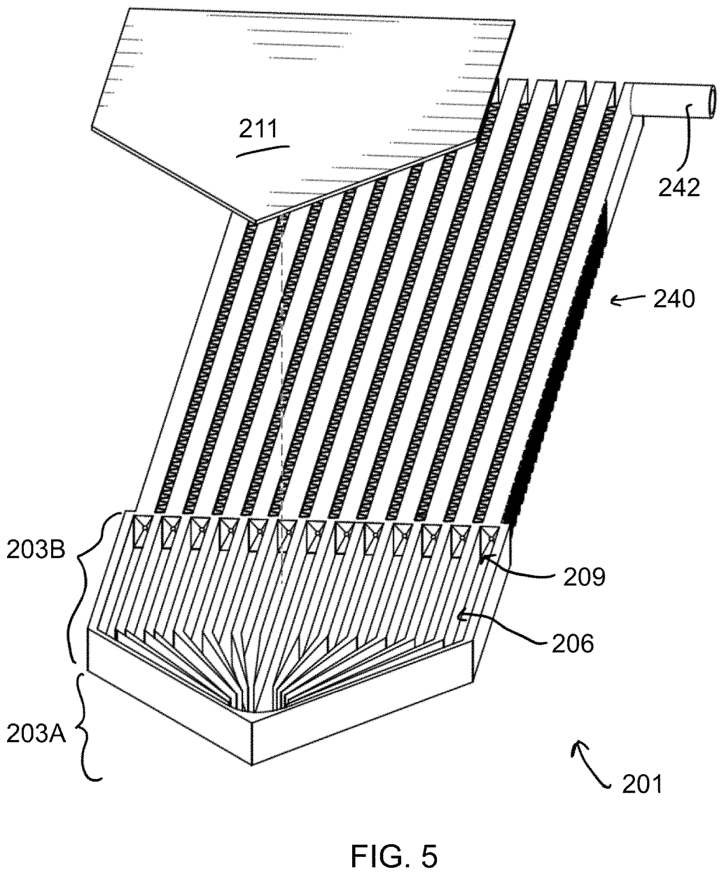

Referring to FIGS. 4-8 and 9D, a second embodiment of a refrigeration system 200 is shown. Similar to the refrigeration system 100, the refrigeration system 200 includes a heat pump 220 in operative association with a Stirling engine 214, although a plurality of Stirling engines 214 may be employed. The heat pump 220 is embodied as a vapor compression refrigeration system to draw ambient heat from one environment using an evaporator 230 and release heat at the condenser 201. In some embodiments, the Stirling engine 214 includes a wheel 217, a cold section 216 and a hot section 215, wherein the hot section 215 rests on an outer side 212 of the lid 211 (FIG. 5) of the condenser 201. Temperature differentials created by the interaction of air heated by the condenser 201 contained at the hot section 215 of the Stirling engine 214 and cooler ambient air contained at the cold section 216 cause the wheel 217 of the Stirling engine 214 to turn, thereby absorbing heat and outputting mechanical work. As shown in FIG. 4, the wheel 217 of the Stirling engine 214 is in operative communication with an alternator 219 via a belt 218, thereby converting the mechanical work in the form of rotational motion of the wheel 217 into electricity. The goal achieved by the condenser 201 is to collect an optimal amount of heat at the condenser 201 in order for the Stirling engine 214 to function. Any heat collected by the Stirling engine 214 from the condenser 201 and converted into electricity is load taken off the compressor 221.

As shown in FIGS. 4 and 9D, the heat pump 220 of the refrigerant system 200 may include condenser 201, evaporator 230, compressor 221 and an expansion valve 224. When gas is compressed, mechanical energy is traded for potential energy in the form of a pressure difference from a high-pressure side and a low-pressure side of the system. Refrigerant is compressed to a higher pressure (and as a result, a higher temperature) using the compressor 221. The hot, pressurized refrigerant gas is then routed to the condenser 201 via a compressor-to-condenser line 222, where the refrigerant gas is cooled and condensed and the heat is drawn out of the condenser 201 and into the hot section 215 of the Stirling engine 214. This results in a lower pressure at the exit valve 209 of the condenser 201. The cooled liquid refrigerant is then routed from the condenser 201 to the expansion valve 224 via a condenser-to-expander line 226, where the liquid refrigerant undergoes expansion and is transformed into a cooled vapor-liquid mixture. The cooled refrigerant then flows to the evaporator 230 via an expander-to-evaporator line 232, where the evaporator 230 absorbs ambient heat in the environment and vaporizes the refrigerant, and the refrigerant is subsequently routed to the compressor 221 via an evaporator-to-compressor line 231, thereby starting the cycle again. In some embodiments, similar to the refrigeration system 100, the expansion valve 224 may be replaced with a turbo-expander 124 (FIG. 9A), the turbo-expander being operatively connected with the compressor 221 via a shaft 127 (FIG. 9A).

As further shown in FIGS. 4-8, the condenser 201 is configured to exchange heat with the Stirling engine 214, rather than the environment. As shown, the condenser 201 defines a lid 211 such that the Stirling engine 214 can be welded, soldered, or otherwise engaged to the lid 211 of the condenser 201 to absorb heat dissipated with in the condenser 201. In some embodiments, the condenser 201 includes a plurality of channels 206, each of the plurality of channels 206 collectively forming a first section 203A and a second section 203B such that refrigerant flows within the plurality of channels 206 from the first section 203A to the second section 203B. As shown, in the first section 203A, each channel 206 extends radially from an entrance valve located at a proximal end of the condenser 201. Hot refrigerant enters each channel 206 of the first section 203A and spreads out towards a plurality of exit valves 209 within each channel 206. In the second section 203B, each channel 206 runs parallel to one another and each channel 206 terminates in a respective exit valve 209, as shown in FIG. 4. At each of the plurality of exit valves 209, the plurality of channels 206 are constricted to hold the refrigerant within the condenser 201 where more of the thermal energy from the refrigerant can be conducted into the Stirling engine 214 before entering the radiator 240. The constriction acts as a stage-one expansion, keeping heat where it can be consumed by the Stirling engine 214. In the embodiment shown, each exit valve 209 leads into a respective channel 242 of the radiator 240, which ensures the refrigerant is cooled to ambient temperature before entering second stage expansion in the evaporator 230 (FIG. 4). As shown, each channel 242 is in fluid flow communication with an outlet 249 which allows refrigerant to leave the radiator 240.

In some embodiments, the area of the condenser 201 not in contact with the Stirling engine 214 is insulated to prevent heat loss. The condenser 201 is modular in design while the entire condenser 201 may be cast or milled out of one piece. As discussed above, in some embodiments, the condenser 201 leads into the radiator 240 to increase the efficiency of the heat pump 220 without dramatically increasing running costs. As shown, the condenser 201 and radiator 240 are separated by the plurality of exit valves 209, each exit valve 209 disposed within a respective channel 206 of the condenser 201. In some embodiments, each exit valve 209 is a ball valve. In this manner, hot refrigerant is held in the condenser 201 and the Stirling engine 214 will continue to operate when the compressor 221 is turned off. In some embodiments, the condenser 201 is insulated with a 3-centimeter or thicker layer of mineral wool or aerogel (not shown). Insulating the condenser 201 ensures that as much heat as possible is forced to run through the Stirling engine 214 to be converted into mechanical work, a process which will be further disclosed below.

The Stirling engine 214 may be soldered or welded to the lid 211 of the condenser 201. In some embodiments, the lid 211 includes a plurality of thin cooling fins 210 (FIG. 8) which are disposed into each of the plurality of channels 206 of the condenser 201. As hot liquid refrigerant runs through the channel 206, the cooling fins draw heat out of the refrigerant in the channel 206 of the condenser 201 and into a hot section 215 of the Stirling engine 214. As a quantity of gas contained in the hot section 215 is heated, the gas expands and cools, moving to a cold section 216 such that more heat will be drawn into the hot section 215, thereby driving a piston (not shown) of the Stirling engine 214. The motion of the Stirling engine 214 produces mechanical rotational energy which is transferred to an alternator 219 to convert the mechanical rotational energy into usable electricity, which can be used by the compressor 221 to continue the cycle or in some embodiments stored in a battery (not shown). Ultimately, the energy from the Stirling engine 214 can be used to power the compressor 221 thus improving a power efficiency of the system 200.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system for harvesting electricity using waste heat from a vapor compression refrigeration system, the system comprising:
a heat pump, the heat pump comprising a condenser and wherein the heat pump is operable for drawing heat from an environment and releasing heat at the condenser;
one or more Stirling engines in operative association with the heat pump, wherein each Stirling engine of the one or more Stirling engines absorbs heat from the condenser and outputs mechanical work; and
one or more alternators in operative engagement with the one or more Stirling engines, wherein each of the one or more alternators is operable for converting mechanical work provided by a respective one of the one or more Stirling engines into electricity.

2. The system of claim 1, wherein the heat pump comprises:
an evaporator in fluid flow communication with the condenser, wherein the evaporator is configured to draw ambient heat from an environment and store the heat in a refrigerant; and
a compressor in fluid flow communication with the evaporator and the condenser, wherein the compressor is configured to compress the refrigerant from the evaporator such that a temperature of refrigerant is increased.

3. The system of claim 2, wherein the condenser is in fluid flow communication with the evaporator and the compressor and wherein the condenser is configured to receive a refrigerant from the compressor and condense the refrigerant such that a pressure and temperature of the refrigerant are lowered.

4. The system of claim 1, further comprising:
a radiator in fluid flow communication with the condenser, wherein the radiator is configured to receive the refrigerant from one or more exit valves of the condenser.

5. The system of claim 1, wherein each Stirling engine of the one or more Stirling engines comprises:
a cold section in thermal communication with an evaporator of the heat pump such that the cold section of each Stirling engine of the one or more Stirling engines is cooled by the evaporator; and
a hot section in thermal communication with the condenser of the heat pump such that the hot section of each Stirling engine is heated by the condenser.

6. The system of claim 5, wherein a temperature differential is generated between the hot section and the cold section of each of the one or more Stirling engines and wherein the temperature differential is used to drive each of the one or more Stirling engines.

7. The system of claim 5, wherein the hot section of the Stirling engine includes a thermal accumulator, wherein the thermal accumulator is configured to trap heat from a light source.

8. The system of claim 1, further comprising:
an alternator, wherein the alternator is in operative engagement with the wheel of each of the one or more Stirling engines.

9. The system of claim 1, wherein the condenser comprises:
a plurality of cooling fins, wherein each of the plurality of cooling fins absorbs heat from refrigerant stored in the condenser and transfers the heat to a hot section of each of the one or more Stirling engines.

10. A condenser, comprising:
one or more channels, wherein each channel of the one or more channels is configured to receive a refrigerant; and
a lid in operative association with the one or channels, wherein the lid further comprises a plurality of cooling fins extending into each of the one or more channels;
wherein heat from the refrigerant is absorbed through the plurality of cooling fins and contained at the lid of the condenser.

11. The condenser of claim 10, wherein the condenser comprises one or more sections, wherein each section of the one or more sections includes a portion of each of the one or more channels.

12. The condenser of claim 11, wherein each section of the condenser is associated with a Stirling engine.

13. The condenser of claim 11, wherein a first section of each of the one or more sections is configured such that the one or more channels radially extend from an entrance valve of the condenser.

14. The condenser of claim 11, wherein a second section of the one or more sections is configured such that each channel of the one or more channels is parallel to one another.

15. The condenser of claim 10, wherein the refrigerant is operable to flow into the one or more channels at an entrance valve and exit the channel at an exit valve.

16. The condenser of claim 10, wherein a majority of a volume defined by the condenser comprises the one or more channels.

17. The condenser of claim 10, wherein each of the plurality of cooling fins extend parallel to a direction of flow of refrigerant, and wherein each of the plurality of cooling fins curve with each channel of the one or more channels.

18. The condenser of claim 10, wherein the one or more channels comprises a single continuous channel.
